(19) United States
(12) Patent Application Publication
(10) Pub. No.: US 2003/0067567 A1
(43) Pub. Date: Apr. 10, 2003

(54) Ferroelectric liquid crystal display and driving method thereof

(75) Inventor: Jong-Min Wang, Seoul (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/195,760

(22) Filed: Jul. 16, 2002

(30) Foreign Application Priority Data
Oct. 10, 2001 (KR) 2001-62460

(51) Int. Cl. G02F 1/1347

(52) U.S. Cl. 349/75

(57) ABSTRACT

A ferroelectric liquid crystal display and a driving method thereof. The ferroelectric liquid crystal comprises a display panel which is disposed between polarizers of which polarization axis are orthogonal to each other, and in which a liquid crystal layer formed between electrode layers is filled with half-V type ferroelectric liquid crystal having a bookshelf structure, the electrode layers being disposed between substrates to be orthogonal and opposite to each other; and a compensation panel which is disposed between the display panel and the polarizer, and in which a liquid crystal layer formed between electrode layers is filled with the half-V type ferroelectric liquid crystal having a bookshelf structure, the electrode layers being disposed between substrates to be opposite to each other. Therefore, the light loss can be reduced, and thus the gray scale display can be improved.

### BACKGROUND OF THE INVENTION

1. Field of the Invention

The present invention relates to a ferroelectric liquid crystal display and a driving method thereof, and more particularly, to a ferroelectric liquid crystal display for an increased light transmittance and a luminance, and a driving method thereof. The present application is based on Korean Patent Application 2001-62460, filed Oct. 10, 2001, which is incorporated herein by reference.

2. Description of the Related Art

A liquid crystal display is a flat type display, which is widely used for a portable device. Due to the fast development in the scale-up technology, the liquid crystal display is rapidly replacing a conventional CRT (cathode ray tube) display.

There are various kinds of liquid crystal materials applied to the liquid crystal display.

A TN (twisted nematic) liquid crystal, which is generally used as the liquid crystal material, utilizes the interaction between dielectric anisotropy of liquid crystal molecules and electric field, causing several drawbacks like an inefficient display of moving pictures due to a slow reaction time of a few tens of milliseconds (ms), and a narrow visual angle. Also, since cross-talk occurs between the pixels within a certain distance, it is difficult to reduce a pixel size.

Meanwhile, an FLCD (ferroelectric liquid crystal display) utilizes the interaction between spontaneous polarization of ferroelectric liquid crystal and electric field, and provides a rapid response property of 1 ms or lower to display moving pictures without any difficulty. It also provides a wide visual angle. The pixel size, in which cross-talk between pixels does not occur, can be reduced due to the strong interaction between molecules in an FLCD, so that high resolution display is achieved. For the advantages as described above, the field of FLCD has been researched extensively as a next-generation display device.

As one of the ferroelectric liquid crystal materials, which is widely used, there is provided a liquid crystal material of a chiral smectic C-phase (SmC*) having a bistable property and a chevron structure.

In a fabricating process of the FLCD device using the liquid crystal material as described above, the liquid crystal material is injected into a cell between substrates, while being maintained at a desired temperature which is higher than a melting point thereof. Then, when the temperature is dropped, the liquid crystal material of chiral smectic C-phase (SmC*) is transformed to a chiral nematic phase (N*), and then to a smectic A-phase having a layer structure perpendicular to a rubbing direction, and then transformed back to the chiral smectic C-phase. In this process, a long-axis direction of a liquid crystal molecule in a liquid crystal layer is tilted to a desired angle relative to the rubbing direction, reducing the space between smectic layers. As a result, the smectic layer is bent in the liquid crystal layer in order to compensate for a change in volume. The bent layer structure is called the chevron structure, and domains are defined, each having a different long-axis direction according to the bending direction. On a boundary surface between the domains, there is formed a non-uniform orientation having a zigzag defect, a hair-pin defect and a mountain defect.

Due to the orientation property as described as above, a contrast ratio is remarkably lowered. If a DC (direct current)voltage is forcibly exerted in order to prevent the lowering of the contrast ratio, ions within the liquid crystal layer are accumulated on or adsorbed into a surface of an alignment film. Therefore, problems like afterimage effect occur, that is, the previous display pattern is dimly displayed on a current display pattern when a previous display state is changed into the current display state.

Further, a ferroelectric liquid crystal material for providing an AFLC (anti ferroelectric liquid crystal) mode, in which the threshold limit is reduced, is actively being researched. However, since it has a spontaneous polarization value of 100 nC/cm², the ions are moved due to a depolarization field, and thus the afterimage can be generated. In addition, in the case where an active matrix driving method is applied where the liquid crystal is independently driven in each pixel using a TFT (thin film transistor), the leakage current can be generated by the large spontaneous polarization value. In order to restrict the leakage current, a capacitance has to be increased. However, in this case, since an aperture ratio is reduced, it is difficult to use it as a display device.

To solve the disadvantage of the ferroelectric liquid crystal, the ferroelectric liquid crystal material having a bookshelf structure has been previously studied, where AC (alternating current) driving can be performed and the afterimage is controlled.

There has been provided a ferroelectric liquid crystal having the bookshelf structure, in which the phase transformation is performed without transformation into the smectic A-phase in a crystallization process. That is, when dropping the temperature from an isotropic state of which the temperature is higher than a melting point, the phase is transformed through the chiral nematic phase (N*) and the chiral smectic C-phase (SmC*) in a crystallization process. As one of the liquid crystals in which the phase is transformed from the chiral nematic phase into the chiral smectic C-phase, there is a half-V type liquid crystal having a mono stable property.

In the half-V type liquid crystal, as shown in FIG. 1, when the potential is not applied, an optical axis of the liquid crystal is parallel to the rubbing direction of an alignment film. When the positive potential is applied, the long axis of the liquid crystal is tilted up to a maximum angle of 45°. In FIG. 1, a reference symbol Vₛₐₜ designates a saturation voltage by which the liquid crystal is maximally tilted.

And when the negative potential is applied, the long axis of the liquid crystal is aligned in a direction which is the same as that of the long axis of the liquid crystal when the potential is not applied. The liquid crystal described above has a relationship between the applied potential and the transmittance, as shown in FIG. 2, i.e., the mono stable property.

Therefore, the liquid crystal has an advantage in that it is possible to perform the AC driving. It is called the half-V type liquid crystal in consideration of the applied potential versus transmittance property.

The half-V type liquid crystal has an advantage of the bookshelf structure. However, when the AC driving is performed in a cycle corresponding to a data display period, as shown in FIG. 3, light is blocked in a negative potential applied region during an AC driving period (T). Therefore, in case the saturation voltage for maximally tilting the liquid crystal is 3V, and if a voltage, which is lower than the saturation voltage, is applied, as indicated in a region A of the AC driving period (T), a transmittance of 50% or below on the average is obtained. Further, if the saturation voltage (3V) is applied, as indicated in a region B, a transmittance of 50% on the average is obtained. The potential is not applied in a region C. In this case, the light is blocked. In the conventional half-V type liquid crystal display, as described above, in case the AC driving is performed to maintain stability of the liquid crystal, there is a disadvantage in that only a maximum average transmittance of 50% is obtained during the displaying period.

In order to restrict the light loss, if an asymmetric DC voltage is applied, ions in the liquid crystal accumulate on a surface, thereby generating the afterimage. Further, there is a problem that the liquid crystal is easily degenerated.

### SUMMARY OF THE INVENTION

It is therefore an object of the present invention to provide a ferroelectric liquid crystal display and a driving method thereof, in which the AC driving of a ferroelectric half-V type liquid crystal can be performed, light loss is restricted, and a gray scale can be displayed.

In accordance with one aspect of the present invention, there is provided a ferroelectric liquid crystal display, comprising a display panel which is disposed between polarizers of which polarization axis are orthogonal to each other, and in which a liquid crystal layer formed between electrode layers is filled with half-V type ferroelectric liquid crystal having a bookshelf structure, the electrode layers being disposed between substrates to be orthogonal and opposite to each other; and a compensation panel which is disposed between the display panel and the polarizer, and in which a liquid crystal layer formed between electrode layers is filled with the half-V type ferroelectric liquid crystal having a bookshelf structure, the electrode layers being disposed between substrates to be opposite to each other.

Preferably, a rubbing direction of an alignment film of the display panel is corresponding to a rubbing direction of an alignment film of the compensation panel.

Further, the material of the half-V type ferroelectric liquid crystal has a property, by which the phase of the half-V type ferroelectric liquid crystal is transformed from a chiral nematic phase into a chiral smectic C-phase while dropping a temperature of the ferroelectric liquid crystal in the crystallization process.

In accordance with another aspect of the present invention, there is a method of driving a ferroelectric liquid crystal display having a first polarizer, a display panel in which half-V type ferroelectric liquid crystal is filled between electrode layers disposed to be orthogonal to each other, a compensation panel in which half-V type ferroelectric liquid crystal is filled between electrode layers disposed to be opposite to each other and a second polarizer, in turn, comprising steps of applying an AC potential to the electrode layer of the compensation panel; and applying an AC potential corresponding to a gray scale of display data to the electrode layer of the display panel.

### BRIEF DESCRIPTION OF THE DRAWINGS

The above and other objects and features of the present invention will become apparent from the following description of the preferred embodiments given in conjunction with the accompanying drawings, in which:

FIG. 1 is a schematic view showing a state that an axis of liquid crystal is tilted in a half-V type ferroelectric liquid crystal having a conventional bookshelf structure according to an intensity of applied voltage;

FIG. 2 is a graph showing a relation between transmittance and the applied voltage of the half-V type ferroelectric liquid crystal of FIG. 1;

FIG. 3 is a graph showing a driving method of a conventional display device in which the half-V type ferroelectric liquid crystal is applied;

FIG. 4 is a schematic view of a ferroelectric liquid crystal display according to the present invention;

FIG. 5 is a cross-sectional view of a compensation panel of FIG. 4;

FIG. 6 is a cross-sectional view of a display panel of FIG. 4;

FIG. 7 is a flow chart showing a driving process for displaying a gray scale corresponding to display data of the ferroelectric liquid crystal display according to the present invention; and

FIG. 8 is a graph showing a relationship between the transmittance and the driving voltage applied to the ferroelectric liquid crystal display according to the driving method of FIG. 7.

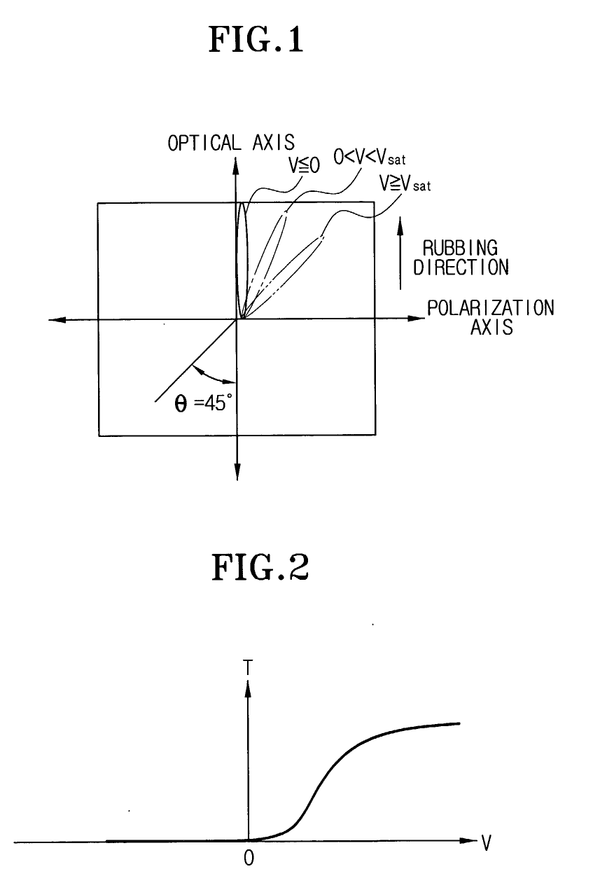

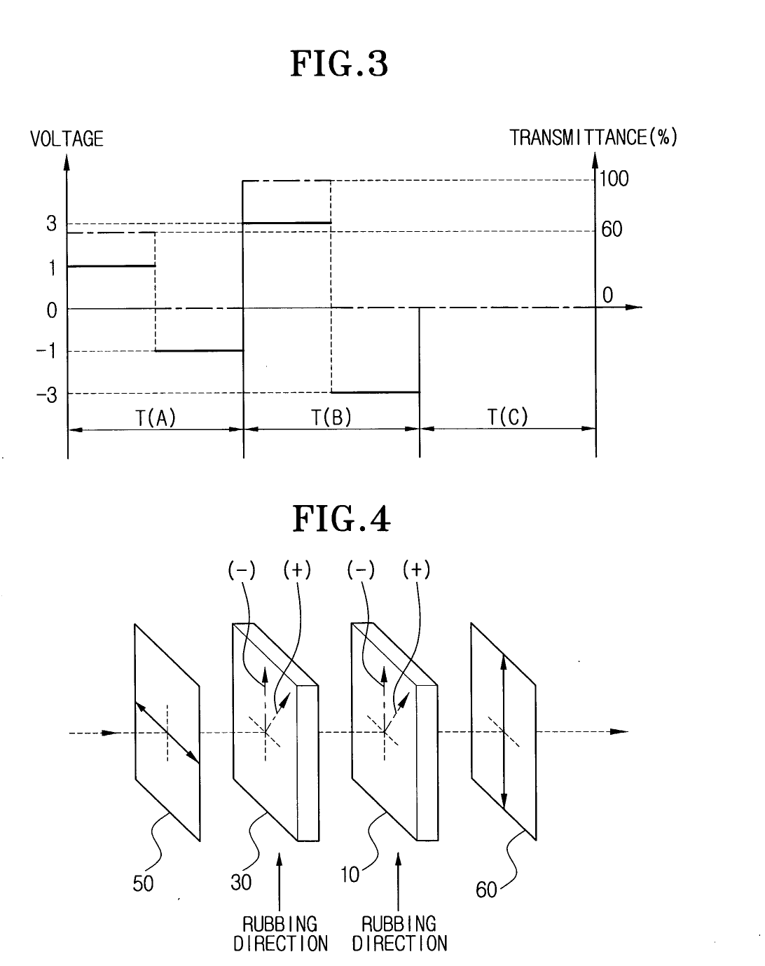

### DETAILED DESCRIPTION OF THE PREFERRED EMBODIMENTS

The preferred embodiment of the present invention will now be described with reference to the drawings.

FIG. 4 is a schematic view of a ferroelectric liquid crystal display according to the present invention.

Referring to FIG. 4, an FLCD (ferroelectric liquid crystal display) is provided with a compensation panel 10 and a display panel 30 which are disposed between first and second polarizers 50 and 60.

Polarization axes of the first and second polarizers 50 and 60 are aligned to be orthogonal to each other.

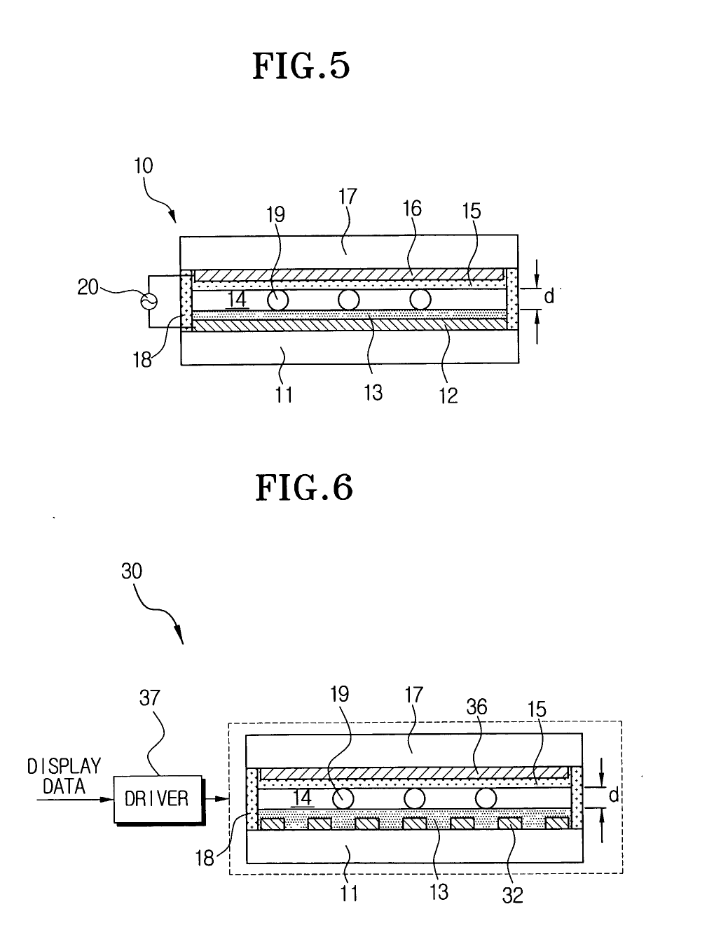

The compensation panel 10, as shown in FIG. 5, includes a lower substrate 11, a lower electrode layer 12, a lower alignment film 13, a liquid crystal layer 14, an upper alignment film 15, an upper electrode layer 16, an upper substrate 17, a sealing member 18 and a spacer 19.

A reference symbol (−) designates a stable state, i.e., an orientation state of liquid crystal when a negative potential or a potential is not applied. A reference symbol (+) designates the orientation state of the liquid crystal when a positive potential is applied.

The liquid crystal layer 14 is filled with a half-V type ferroelectric liquid crystal material having a bookshelf structure formed by a crystallization process according to the present invention.

The half-V type ferroelectric liquid crystal having the bookshelf structure has a structure that liquid crystal molecules are aligned side by side in rows without bending in a smectic layer which is vertically aligned through a crystallization process. In the half-V type ferroelectric liquid crystal layer, if a corresponding liquid crystal is injected in a melted state and then a temperature of the liquid crystal is dropped, a phase of the liquid crystal is transformed from a chiral nematic phase (N*) into a chiral smectic C-phase (SmC*), thereby forming a desired structure.

There are provided various kinds of half-V type liquid crystal materials. In this embodiment, the half-V type liquid crystal fabricated by Clariant Inc. in Japan is applied.

The lower and upper substrates 11 and 17 are formed of a transparent material such as glass or transparent synthetic resin.

The lower and upper electrode layers 12 and 16 are formed of a transparent conductive material, e.g., ITO material. Preferably, the lower and upper electrode layers 12 and 16 are formed of a single electrode plate having a size corresponding to a displaying screen, respectively.

The lower and upper alignment films 13 and 15 are formed of various well-known aligning materials, e.g., polyimide, polyvinyl alcohol, nylon, PVA series and so forth.

The alignment films 13 and 15 are rubbing-processed at a desired angle by a rubbing material like cloth.

The spacer 19 is disposed to constantly maintain a gap d of the liquid crystal layer 14 between the upper and lower layers.

The gap d of the liquid crystal layer is determined so that a product of the gap d and a refractive index anisotropy (Δn) of the half-V type liquid crystal satisfies a condition of λ/2 where (λ) is a wavelength of incident light. That is, the gap d of the liquid crystal layer 14 is determined according to a refractive index anisotropic value of the half-V type ferroelectric liquid crystal so that the compensation panel 10 has a function of a half plate with respect to the wavelength (λ) of incident light.

A reference numeral 20 is an AC driving source for applying a desired AC potential through the electrode layers 12 and 16 in a desired period to the half-V type ferroelectric liquid crystal injected into the liquid crystal layer 14, when driving the display device.

Meanwhile, the display panel 30 has a well-known structure for independently driving a pixel corresponding to displaying data.

FIG. 6 is a cross-sectional view showing a structure of the display panel of FIG. 4. The same elements as those in FIG. 5 are defined by the same reference numerals.

Referring to FIG. 6, a display panel 30 includes a lower substrate 11, a lower electrode layer 32, a lower alignment film 13, a liquid crystal layer 14, an upper alignment film 15, an upper electrode layer 36, an upper substrate 17, a sealing member 18 and a spacer 19.

The lower and upper electrode layers 32 and 36 of the display panel 30 have different structures from those of the compensation panel 10.

The lower and upper electrode layers 32 and 36 have a plurality of electrodes aligned in different directions to be orthogonal to each other.

The liquid crystal layer 14 of the display panel 30 is filled with the same liquid crystal material as that filled in the liquid crystal layer 14 of the compensation panel 10. That is, the liquid crystal material is the half-V type liquid crystal material.

Preferably, the display panel 30 and the compensation panel 10 are aligned so that the rubbing direction of the alignment films 13 and 15 of the display panel 30 is to the same as the rubbing direction of the alignment films 13 and 15 of the compensation panel 10.

The spacer 19 is disposed to constantly maintain a gap d of the liquid crystal layer 14 between the upper and lower layers.

Further, in the like manner as the compensation panel 10, the gap d of the liquid crystal layer 14 of the display panel 30 is determined such that a product of the gap d and the refractive index anisotropy (Δn) of the half-V type liquid crystal satisfies a condition of λ/2 where (λ) is a wavelength of incident light. That is, the gap of the liquid crystal layer 14 is determined according to the refractive index anisotropic value of the half-V type ferroelectric liquid crystal so that the display panel 30 has a function of the half plate with respect to the wavelength (λ)of incident light.

A reference numeral 37 is a driver for applying a potential to the electrode layers 32 and 36, in a desired period, through the half-V type ferroelectric liquid crystal injected into the liquid crystal layer 14, to each pixel according to the display data.

The driver 37 is connected to the electrode layers 32 and 36 so as to apply the AC potential corresponding to gray scale data of the display data through the electrode layers 32 and 36.

In the ferroelectric liquid crystal display, if the display panel 30 and the compensation panel 10 are driven so that a light transmitting property is compensated periodwhile the applied potential and phase is properly varied during a predetermined data display period such that the transmittance, with respect to the incident light, can be extended to 100%.

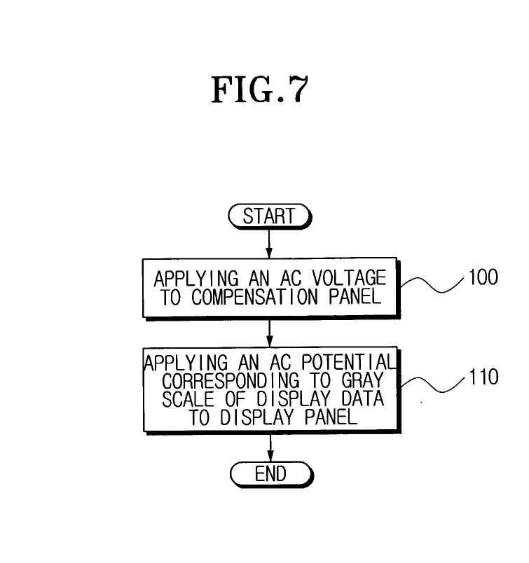

FIG. 7 shows a preferable driving process of the ferroelectric liquid crystal display.

A desired AC voltage is applied to the compensation panel 10 (step 100). An AC potential, corresponding to the gray scale of the display data, is applied to the display panel 30 (step 110).

That is, in the compensation panel 10, the AC driving is performed with a voltage which is preset the same as or higher than the saturation voltage corresponding to the maximum tilt angle of 45°. In the display panel 30, a level and a phase of the applied AC voltage are varied corresponding to the AC driving period of the compensation panel 10 so as to be capable of obtaining the transmittance corresponding to the display data.

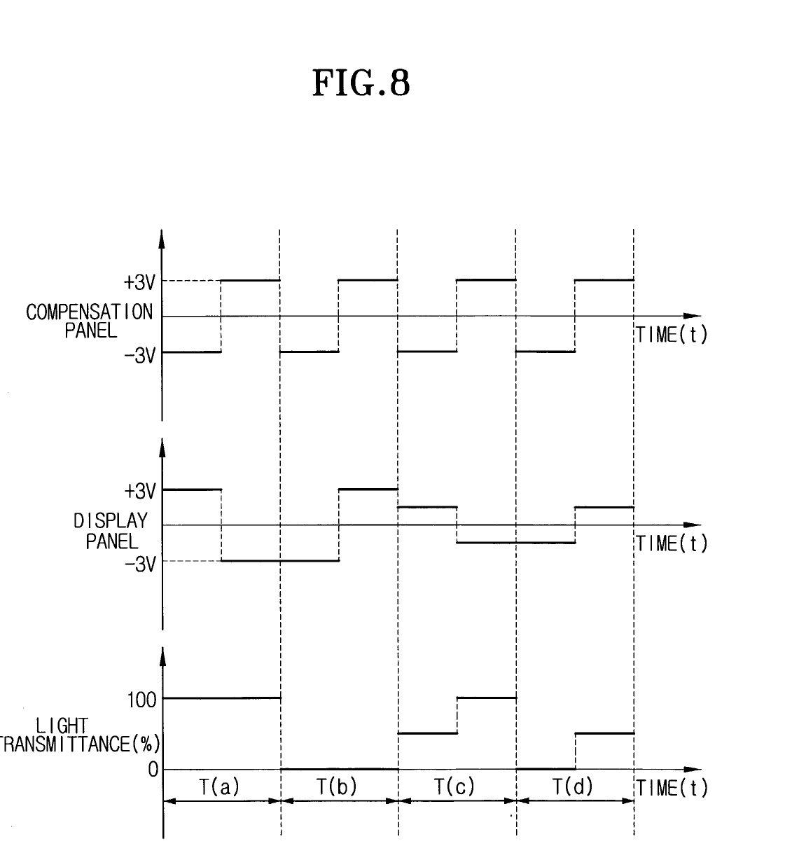

FIG. 8 shows an embodiment in which the liquid crystal display is driven in the aforementioned manner.

As shown in FIG. 8, in case the saturation voltage corresponding to the maximum tilt angle of the liquid crystal is 3V, an AC potential of ±3V is applied to the compensation panel 10 during the preset data display period (T), e.g., a frame period of 16.6 ms. An AC voltage corresponding to the gray scale information of the display data is applied to the display panel 30 during the data display period (T).

In the drawing, if a saturation AC potential having a reverse phase to the AC potential applied to the compensation panel 10 is applied to the display panel 30, as described in a region T(a), an average transmittance becomes 100% during a pixel display period. And if a saturation AC potential having the same phase as the AC potential applied to the compensation panel 10 is applied to the display panel 30, as described in a region T(b), the transmittance becomes zero during the pixel display period. Therefore, according to the level and phase of the AC potential applied to the display panel 30, the average transmittance can be varied from zero to 100% during the display period (T). Thus, a gray scale displaying extent can be precisely segmented.

That is, if a voltage, which is lower than a minimum voltage corresponding to the maximum tilt angle of the liquid crystal, is applied to the display panel 30 in the reverse phase to the AC potential applied to the compensation panel 10, as described in a region T(c), the average transmittance range during a pixel display period is determined to be 50-100%.

In the same manner, if the voltage, which is lower than a minimum voltage corresponding to the maximum tilt angle of the liquid crystal, is applied to the display panel 30 in the same phase as the AC potential applied to the compensation panel 10, as described in a region T(d), the average transmittance range during a pixel display period is determined to be 0-50%.

In the above embodiment, the AC voltage, which is higher than the saturation voltage corresponding to the maximum tilt angle of the liquid crystal, is applied to the compensation panel 10. And, the AC potential having the phase and level corresponding to the gray scale to be displayed is applied to the display panel 10. However, it is possible to vary the level of the AC potential applied to the compensation panel 10 and thus control the level and the phase of the AC potential applied to the display panel 30 corresponding to the gray scale to be displayed.

According to the FLCD and a driving method thereof of the present invention, as described above, the light loss can be reduced, and thus the gray scale displaying extent can be extended.

While the invention has been shown and described with reference to the preferred embodiments thereof, it will be understood by those skilled in the art that various changes in form and details may be made therein without departing from the sprit and scope of the invention as defined by the appended claims.

What is claimed is:

1. A ferroelectric liquid crystal display, comprising:
a display panel which is disposed between polarizers of which polarization axes are orthogonal to each other, and in which a first liquid crystal layer formed between first electrode layers is filled with a half-V type ferroelectric liquid crystal having a bookshelf structure, the first electrode layers being disposed between first substrates to be orthogonal and opposite to each other; and
a compensation panel which is disposed between the display panel and one of the second polarizers, and in which a second liquid crystal layer formed between second electrode layers is filled with the half-V type ferroelectric liquid crystal having a bookshelf structure, the second electrode layers being disposed between second substrates to be opposite to each other.

2. The display of claim 1, wherein a rubbing direction of an alignment film of the display panel corresponds to a rubbing direction of an alignment film of the compensation panel.

3. The display of claim 1, wherein a material of the half-V type ferroelectric liquid crystal has a property by which the phase of the half-V type ferroelectric liquid crystal is transformed from a chiral nematic phase into a chiral smectic C-phase during a crystallization process.

4. A method of driving a ferroelectric liquid crystal display having a first polarizer, a display panel in which half-V type ferroelectric liquid crystal is filled between first electrode layers disposed to be orthogonal to each other, a compensation panel in which half-V type ferroelectric liquid crystal is filled between second electrode layers disposed to be opposite to each other and a second polarizer, in turn, comprising steps of:
applying an AC potential to the second electrode layers of the compensation panel; and
applying an AC potential corresponding to a gray scale of display data to the first electrode layers of the display panel.
